(19) United States
(12) Patent Application Publication
(10) Pub. No.: US 2025/0388723 A1
(43) Pub. Date: Dec. 25, 2025

(54) SILYL ETHER-CONTAINING POLYMERS AND USES THEREOF

(71) Applicant: ENTEGRIS, INC., Billerica, MA (US)

(72) Inventors: Brandon J. Ackley, Waltham, MA (US); Upamanyu Ray, Lowell, MA (US); Christopher W. Livesey, Norwood, MA (US); Pushkara Rao Varanasi, Poughkeepsie, NY (US); David Medeiros, West Stockbridge, MA (US); Frank O. Onyemauwa, Chelmsford, MA (US)

(21) Appl. No.: 19/233,050

(22) Filed: Jun. 10, 2025

Related U.S. Application Data
(60) Provisional application No. 63/664,078, filed on Jun. 25, 2024.

(51) Int. Cl. C08G 65/336

(52) U.S. Cl. CPC C08G 65/336

(57) ABSTRACT

Described are silyl ether-containing polymers and methods of preparing and using silyl ether-containing polymers, methods of preparing silyl ether-containing polymers, and methods of using silyl ether-containing polymers as a flow control device.

### CROSS-REFERENCE TO RELATED APPLICATION

This application claims priority to and the benefit of U.S. Provisional Application No. 63/664,078 filed on Jun. 25, 2024 which is incorporated herein by reference in its entirety for all purposes.

### FIELD

The present description relates to silyl ether-containing polymers and methods of preparing and using silyl ether-containing polymers.

### BACKGROUND

Specialized polymers such as fluoropolymers, silicones, and functionalized organic polymers have a range of industrial and consumer applications. Certain polymers are favored for different industrial applications for their resistance to high temperatures and reactive chemicals. Various specialized polymers have been designed for these applications, including specialized polyolefins (e.g., polyethylenes, polypropylenes), poly(aryletherketone) polymers (PAEK), fluoropolymers (fluorinated and perfluorinated polymers), and polysulfones, among others. Some of these polymers may be chemically modified or crosslinked to affect temperature resistance, chemical resistance, and surface properties, etc. Useful polymers are stable at high temperatures, resistant to various chemicals, such as concentrated acids, and can be efficiently processed to form useful articles such as components of a fluid handling system. Such polymers may be used in the life sciences, chemical processing, and semiconductor manufacturing industries.

### SUMMARY

The following describes novel silicon-modified polymers and methods of preparing these. Example silicon-modified polymers comprise organic polymer having a silyl-ether group, meaning a silyl group that is connected to the organic polymer through an oxygen atom.

Examples of the silicon-modified polymers can include a backbone of a type referred to generally or specifically as poly(aryl ether ketones) or “PAEK,” polyvinyl phenols, polyether ketones (PEK), polyether ether ketones (PEEK), polyvinyl alcohols, and polyketones, e.g., are silicon-modified versions of these polymers.

The silicon-modified polymer may have useful or improved stability and mechanical properties such as strength (e.g., physical toughness), modulus, and resistance to chemical degradation, including resistance to acids such as concentrated sulfuric acid. These improved properties make the silicon-modified polymer, as disclosed herein, potentially useful for fabricating various components of a fluid handling system such as, for example, used in the semiconductor or life science industries.

A silyl ether-containing polymer may be prepared by reacting a polymer having a reactive oxygen atom (a “base polymer”) with a reactive silicon compound to attach the reactive silicon compound to the reactive base polymer through the reactive oxygen atom, forming a silyl ether group. The silicon-modification efficiency for each monomer unit can range from 1 to 90% by mass. Once silicon-modified, the silyl ether-containing polymer can be further chemically and thermally crosslinked, resulting in a network of O—Si—O—Si linkages. This Si—O network serves to impart improved acid resistance while retaining the chemical resistance and mechanical properties of the base polymer. The Si—O network is covalently bound to the polymer backbone and not a coating, so it is not prone to the failure mechanisms typical for coatings (e.g., delamination, cracking). With improved chemical resistance, together with increases in elongation, these polymers may be used to replace fluorinated polymers.

In one aspect, the description relates to a silyl ether-containing polymer that includes organic polymer and a silyl group connected to the organic polymer through an oxygen atom.

In another aspect, the description relates to a method of preparing a silyl ether-containing polymer. The method includes reacting organic polymer that contains an organic backbone and a reactive oxygen group with reactive silicon compound to attach a silicon atom of the reactive silicon compound to the organic polymer through an oxygen atom of the reactive oxygen groups.

In yet another aspect, the disclosure relates to a flow control device that includes silyl ether-containing polymer containing: organic polymer, and a silyl group connected to the organic polymer through an oxygen atom.

### DETAILED DESCRIPTION

There is increasing interest in reducing the need for fluorinated polymers. Industries are searching for non-fluorinated replacement polymers that exhibit material and processing properties that are similar to those of fluorinated polymers, such as temperature resistance, chemical resistance, resistance to acids, and processability.

Described are silicon-modified polymers that include organic polymer comprising one or more silyl groups connected to the organic polymer through an oxygen atom, also referred to as “silyl ether groups.”

Example silyl ether-containing polymers include an organic backbone (or “polymer backbone” or “backbone”) and the silyl ether groups attached to the organic polymer. Example organic polymers may contain aromatic groups as part of the backbone or attached to the backbone. A silyl group may be attached to an oxygen atom that is directly attached to the polymer backbone or may instead be attached to an oxygen atom that is part of a chemical group that is attached to the backbone (see, e.g., the poly(vinyl phenol) examples described below).

A silicon (Si) atom of the silyl group is attached to the oxygen atom and has three remaining chemical bonds. The three remaining chemical bonds may bond the silicon atom to one or more hydrogen atoms, one or more organic groups, a divalent group (e.g., alkylene) that connects to another silicon atom, or an oxygen atom that connects to either another silicon atom or an organic group.

According to certain more specific examples of silyl ether-containing polymers, a silyl group can be described according to formula I:

—SiR1R2R3

In formula 1, the silicon atom (Si) is connected to an oxygen atom of the organic polymer to connect the silyl group to the polymer through the oxygen atom, either directly at a carbon atom of the polymer backbone, or indirectly through another organic group (e.g., a divalent alkyl group, aromatic group, or the like). The silicon atom also includes three additional bonds, each of which independently attaches to: an organic group, a hydrogen atom, an oxygen atom that connects to another silicon atom, or to a divalent group (e.g., alkylene) that connects to either another silicon atom or an organic group.

According to certain example silyl groups of formula 1, each of R1 and R2 may independently be hydrogen or an organic group (e.g., an alkyl, an alkoxy, an aromatic group, or hydroxy group), and R3 may be hydrogen, an organic group (e.g., an alkyl, an alkoxy, an aromatic group, or a hydroxy (—OH) group), or a divalent oxygen or organic group that connects to another silicon atom, e.g., —X—Si(R4)Si(R5)- wherein X is a divalent oxygen or a divalent alkylene, and each R4 and R5 is an oxygen connected to another silicon atom.

As represented by these example structures, a silyl ether group that contains the silyl group can have the formula:

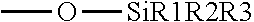

with the oxygen atom being connected to the polymer backbone.

Example silyl ether groups include the following:

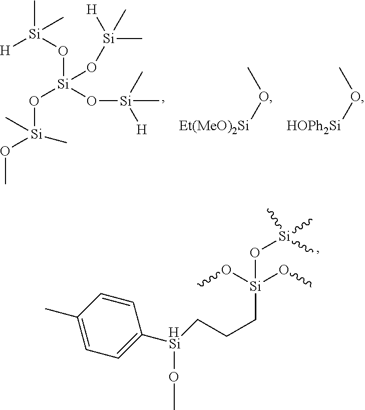

wherein

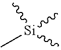

represents a silicon atom substituted with three organic (e.g., alkyl) groups, and

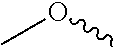

represents an alkoxy group.

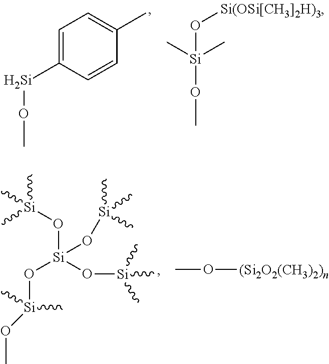

wherein n is in a range from 1 to 10,

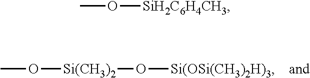

oligomeric silicates and oligomeric siloxanes such as poly(dimethylsiloxane)

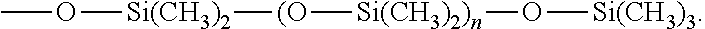

Example organic polymers and organic polymer backbones of a silyl ether-containing polymer may include any useful polymer or polymer backbone. Examples include “aromatic polymers” that contain an aromatic group within the backbone or attached to the backbone. Some specific examples include poly(aryl ether ketone) (PAEK), e.g., polyether ether ketone (PEEK), polyether ketone ketone (PEKK), or polyether ketone (PEK). Other examples include polyvinyl phenol, polyvinyl alcohol, and polyketone. These polymers or polymer backbones may be homopolymers or co-polymers and may be derived from monomers typically used to form such polymers, e.g., vinyl phenol, vinyl alcohol, styrene, allyl alcohol, ketones.

A silyl ether-containing polymer as described herein may be derived by reacting a polymer having a reactive oxygen atom (i.e., a “reactive oxygen group”) (a “base polymer”) with a reactive silicon compound to attach the reactive silicon compound to the reactive base polymer through the reactive oxygen atom, forming a silyl ether group. The base polymer can exhibit certain compositional, mechanical, and stability (chemical and thermal resistance) properties that are also desirable in the silyl ether-containing polymer. Certain examples of useful base polymers (described in more detail below) include polymers generally considered to be thermoplastic polymers that are semi-crystalline and that exhibit useful thermal and chemical stability properties.

A silyl ether-containing polymer may be of any useful length, e.g., molecular weight, depending on desired properties and a desired use of the polymer. In a non-limiting fashion, and while silyl ether-containing polymers outside of this range may be useful, certain specific examples of silyl ether-containing polymers may have a molecular weight in a range from 15,000 to 105,000 Dalton, e.g., from 25,000 to 45,000 Dalton for PEEK, PEK, and PEKK.

The silyl ether-containing polymer can have useful mechanical properties, surface properties (e.g., for filtering applications), and resistance to chemicals such as concentrated acids. Certain example polymers may have improved mechanical and stability properties when compared to the same polymer without the silicon modification, i.e., a base polymer without the silyl-ether groups. These include enhanced stability in the presence of reactive chemicals, including stability in the presence of an acid, physical toughness, and measured as increased elongation properties.

Example silyl ether-containing polymers may have increased resistance to acids, e.g., concentrated acids such as concentrated sulfuric acid, relative to a base polymer used to prepare the silyl ether-containing polymer. Resistance to concentrated sulfuric acid can be tested by known methods, including by prolonged exposure of a polymer to concentrated sulfuric acid at ambient temperature (˜24 C).

Example silyl ether-containing polymers may have improved mechanical properties as measured by elongation, e.g., maximum elongation. A silyl ether-containing polymer may have a measured maximum elongation value that is at least 25, 50, 75, or 100 percent higher than a maximum elongation value of a base polymer used to prepare the silyl ether-containing polymer. Maximum elongation of a polymer is a known property of a polymer and can be measured by known methods, including by standard testing according to ASTM D882 or ASTM D638.

Example silyl ether-containing polymers may have an improved toughness property compared to a base polymer used to prepare the silyl ether-containing polymer. A silyl ether-containing polymer may have a measured toughness 100, 200, or 300 percent higher than a toughness value of a base polymer used to prepare the silyl ether-containing polymer. Toughness of a polymer is a known property of a polymer and can be measured by known methods, including by standard testing according to ASTM D882.

A silyl ether-containing polymer may be prepared by a method that includes reacting an organic polymer that includes an organic backbone and reactive oxygen groups (this polymer being referred to as a “base polymer”) with reactive silicon compound. The backbone of the base polymer can be one that provides an organic polymer backbone of the silyl ether-containing polymer, including as described elsewhere herein. Example base polymers can include a reactive oxygen that is part of a hydroxy group (—OH) or that is part of a carbonyl group (═C═O), either of which may be included within or directly connected to the backbone of the organic polymer, or may be included in or connected to a chemical group that is attached to (pendant from) the backbone of the organic polymer, e.g., as with poly(vinyl methyl ketone).

A reaction of the base polymer with the reactive silicon compound causes the reactive silicon compound to react with the reactive oxygen group of the base polymer in a manner that causes the silicon atom of the reactive silicon compound to become attached to the oxygen atom of the reactive oxygen group to form a silyl ether group attached to the base polymer. This reaction between a base polymer and the reactive silicon compound can involve two different sets of reactant types and two different reaction mechanisms which are: a condensation reaction, and a hydrosilylation reaction.

By a condensation reaction mechanism, the base polymer includes a reactive hydroxy group (—OH) that reacts with a reactive silicon compound that is a silanol or a silyl ether, e.g.,

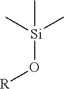

wherein R is —OH or an alkoxy group (i.e., —O-alkyl), e.g., —OCH₃. The —OH or —O-alkyl (e.g., —OCH₃) group of the reactive silicon compound can react with the base polymer according to the following general reaction scheme. (The illustrated reaction is exemplary of the condensation reaction between a reactive hydroxy group (—OH) of a generic base polymer and a reactive —OH or —OCH₃ group of a generic reactive silicon compound; the reaction may alternately be performed with any useful base polymer and silanol or silyl ether compound including as described herein, e.g., with R being CH₃ or a different alkyl):

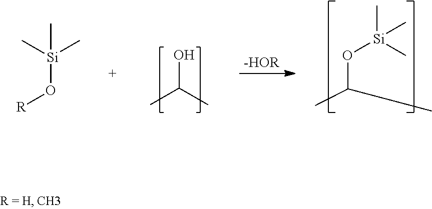

The reactive silicon compound may be a compound generally referred to as a silanol, wherein R is a hydrogen, or a compound generally referred to as a silyl ether, when R is preferentially CH₃ but can be any alkyl. Example reactive silicon compounds, e.g., silanols and silyl ethers, may have any useful molecular weight, e.g., a molecular weight in a range from 90 to 1,000; e.g., example silanols may have a molecular weight in a range from 90 to 200 Daltons and example silyl ethers may have a molecular weight in a range from 100 to 400 Daltons.

A useful silanol may be any silanol that can be reacted with the base polymer to attach a desired silyl ether group onto the base polymer. Examples may include any silanol, e.g., silanediol, diphenylsilanediol, diisobutylsilanediol, tris(tertbutoxy)silanol, tertbutylsilanetriol, and poly(methylsilsesquioxane).

A useful silyl ether may be any silyl ether that can be reacted with the base polymer to attach a desired silyl ether group onto the base polymer. Examples include tetraethoxysilane, ethyl(trimethoxy)silane, tetramethoxysilane, tetramethoxysilane oligomeric hydrolysate, methoxy terminated poly(methylsilsesquioxane), and other silsesquioxanes.

A condensation reaction as described can be performed at any useful conditions, such as at an elevated temperature, in a desired solvent, and with the optional use of a catalyst. According to example methods, a useful temperature may be in excess of 100 degrees Celsius, to drive off a water or alcohol by-product of the condensation reaction. A useful catalyst for the reaction may be a basic catalyst such as sodium hydroxide, ammonium hydroxide, or the like.

By a hydrosilylation reaction mechanism, the base polymer includes a reactive carbonyl oxygen (═C═O) that reacts with a reactive hydrogen of the reactive silicon compound according to the following general reaction scheme. (The illustrated reaction is exemplary of the condensation reaction between a reactive carbonyl oxygen of a generic base polymer and a reactive hydrogen of a generic reactive silicon compound, and the reaction can be performed with any useful base polymer and reactive silicon compound including as described herein):

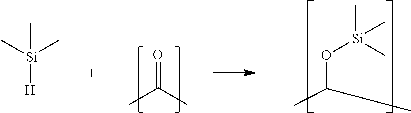

Useful reactive silicon compounds include silane compounds containing reactive silicon-bonded hydrogen, that can be reacted with a carbonyl oxygen of the base polymer to attach a desired silyl group to the organic polymer at the carbonyl oxygen. Example reactive silicon compounds, e.g., silanes, may have any useful molecular weight, e.g., a molecular weight in a range from 96 to 10,000. Example silane compounds include tetrakis(dimethylsiloxy)silane, para(tolyl)silane, diphenylsilane, phenylsilane, triphenylsilane, poly(methyl-hydrosilsesquioxane).

A hydrosilylation reaction as described can be performed at any useful conditions, such as at an elevated temperature, in a desired solvent, and with the optional use of a catalyst. According to example methods, a useful temperature may be over 100 C in a moisture-free atmosphere, using a polar aprotic solvent. A catalyst useful for the hydrosilylation reaction is Karstedt's catalyst (Platinum(0)-1,3-divinyl-1,1,3,3-tetramethyldisiloxane), though other platinum, palladium, and base-metal catalysts may also be useful.

According to each of the condensation reaction and the hydrosilylation reaction, the base polymer contains a reactive oxygen that is either a reactive hydroxy (—OH) group (for the condensation reaction mechanism) or a reactive carbonyl oxygen (═C═O) (for the hydrosilylation reaction).

A base polymer includes an organic backbone and a reactive oxygen as described. Example base polymers include poly(aryl ether ketone) (PAEK), e.g., polyether ether ketone (PEEK), polyether ketone ketone (PEKK), or polyether ketone (PEK). Other examples include polyvinyl phenol, polyvinyl alcohol, and polyketone. These polymers or polymer backbones may be homopolymers or co-polymers and may be derived from monomers typically used to form such polymers, e.g., vinyl phenol, vinyl alcohol, styrene, allyl alcohol, and ketones.

A base polymer may exhibit certain compositional, mechanical, and stability (chemical and thermal resistance) properties that will contribute these same properties to a silyl ether-containing polymer prepared from the base polymer. Example base polymers include polymers generally considered to be thermoplastic polymers that are semi-crystalline and that exhibit useful thermal and chemical stability properties. Example base polymers may include aromatic groups as part of a backbone, or pending from a backbone, and may contain halogen atoms such as chlorine atoms.

A base polymer may be of any useful length, e.g., molecular weight, depending on desired properties and a desired use of the polymer. In a non-limiting fashion, and while base polymers outside of this range may be useful, certain specific examples of base polymers may have a molecular weight in a range from 10,000 to 100,000 Dalton, e.g., from 20,000 to 40,000 Dalton for PEEK, PEK, and PEKK.

The base can have useful mechanical properties, surface properties (e.g., for filtering applications), and resistance to chemicals such as concentrated acids. These properties may also be useful in a silyl ether-containing polymer derived from the base polymer. A base polymer and a silyl ether-containing polymer may be considered to be thermally stable, being resistant to unacceptable chemical breakdown during continuous uses at 200 degrees Celsius or above. These polymers may be stable at operating temperatures up to or in excess of 260 degrees Celsius and may exhibit a melting temperature in excess of 390 degrees Celsius (for polyetherketoneketone (PEKK)), or 335 degrees Celsius (PEEK, or above 350 (PAEK). A silyl ether-containing polymer derived from a thermally stable base polymer may also exhibit thermal stability in a range as described.

Silyl ether-containing polymers as described include the following, as non-limiting examples.

A silyl ether-containing polymer prepared from a PEEK base polymer by reacting carbonyl groups of the PEEK base polymer with reactive silicon compound to add a silyl group at the carbonyl oxygen can have the following structure, with R representing a silyl group:

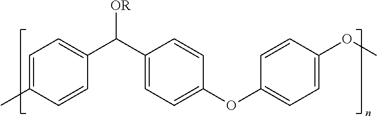

A silyl ether-containing polymer prepared from a PEKK base polymer by reacting carbonyl groups of the PEKK base polymer with reactive silicon compound to add a silyl group at the carbonyl oxygen can have the following structure, with R representing a silyl group:

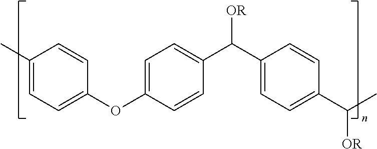

A silyl ether-containing polymer prepared from a PEK base polymer by reacting carbonyl groups of the PEK base polymer with reactive silicon compound to add a silyl group at the carbonyl oxygen can have the following structure, with R representing a silyl group:

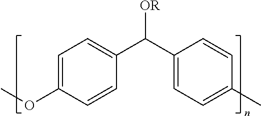

A silyl ether-containing polymer prepared from a poly(vinyl phenyl-co-vinyl alcohol) base polymer by reacting hydroxy groups of the poly(vinyl phenyl-co-vinyl alcohol) base polymer with reactive silicon compound to add a silyl group at the hydroxy group can have the following structure, with R representing a silyl group:

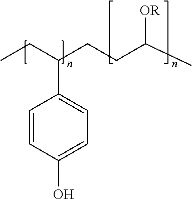

As illustrated, the phenol alcohol is not converted, however, this phenol alcohol may alternately or additionally be converted to a silyl ether group, as desired. The phenol may be converted depending on the reaction conditions. Conditions that target the reactive carbonyl oxygen will generally not interact with the phenolic —OH, and conditions that target the phenolic —OH will generally not interact with the carbonyl oxygen. According to such example methods, it is possible to selectively add silyl ether groups to the base polymer at one or multiple different reactive oxygen atoms.

A silyl ether-containing polymer prepared from a poly(styrene-co-vinyl alcohol) base polymer by reacting hydroxy groups of the poly(styrene-co-vinyl alcohol) base polymer with reactive silicon compound to add a silyl group at the hydroxy group can have the following structure, with R representing a silyl group:

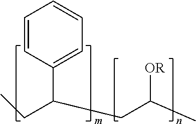

A silyl ether-containing polymer can be prepared from PEEK base polymer by first reacting the PEEK polymer with Piranha solution (a strongly oxidizing solution made from hydrogen peroxide and sulfuric acid) to oxidize the PEEK polymer and attach an —OH group to the aromatic ring. Next, carbonyl groups of the base polymer are reacted with tetrakis(dimethylsiloxy) silane to add a silyl group at the carbonyl group. A second reactive silicon compound (e.g., ethyl(trimethyoxy)silane) is then reacted to the —OH group produced by the oxidizing step to form a second silyl ether group as part of the polymer and attached to an aromatic ring of the backbone. The two silyl group that are added in the first reaction step and in the second reaction step can be the same or different. The resulting silyl ether-containing polymer can have the following structure:

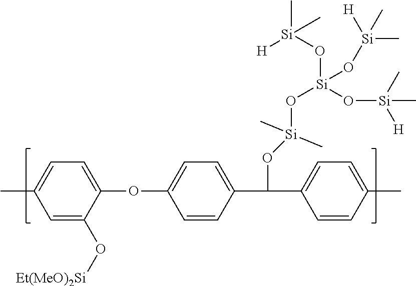

A silyl ether-containing polymer can be prepared from PEEK base polymer by first reacting the PEEK polymer with Piranha solution (a strongly oxidizing solution made from hydrogen peroxide and sulfuric acid) to oxidize the PEEK polymer and attach an —OH group to the aromatic ring. Next, carbonyl groups of the base polymer are reacted with tetrakis(dimethylsiloxy) silane to add a silyl group at the carbonyl group. A second reactive silicon compound (e.g., diphenylsilanediol) is then reacted to the —OH group produced by the oxidizing step to form a second silyl ether group as part of the polymer and attached to an aromatic ring of the backbone. The two silyl group that are added in the first reaction step and in the second reaction step can be the same or different. The resulting silyl ether-containing polymer can have the following structure:

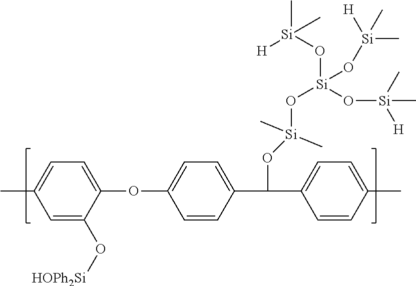

A silyl ether-containing polymer prepared from a PEEK base polymer by first reacting the PEEK polymer with aqua regia (a strongly oxidizing solution made from nitric acid and hydrochloric acid) to oxidize the PEEK polymer and attach a —Cl group to the aromatic ring. Next, carbonyl groups of the base polymer are reacted with reactive silicon compound (e.g., paratolylsilane) to add a silyl group at the carbonyl group, which is then further reacted with vinyl(trimethoxy)silane. The resulting silyl ether-containing polymer can have the following structure:

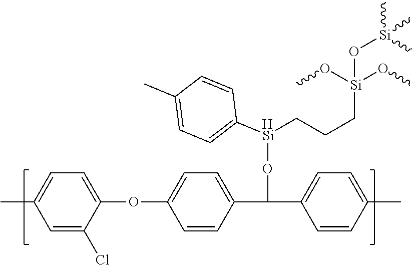

A silyl ether-containing polymer can be prepared from a PEEK base polymer by first reacting the PEEK polymer with methane sulfonic acid, chloromethyl octyl ether, and sulfuric acid to oxidize the PEEK polymer and attach an —CH₂Cl group to the aromatic ring. Next, carbonyl groups of the PEEK base polymer are reacted with reactive silicon compound (e.g., tetrakis(dimethylsiloxy) silane) to add a silyl group at the carbonyl group. The resulting silyl ether-containing polymer can have the following structure:

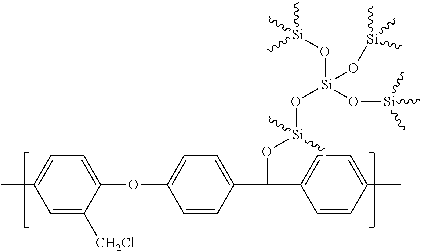

A silyl ether-containing polymer may also be crosslinked. For example, after forming a silyl ether-containing polymer, the polymer may be crosslinked or “cured” by exposing the polymer to high temperature for a sufficient amount of time to cause a silyl ether group of a polymer to become chemically bonded to a second silyl ether-containing polymer. The temperature can be selected to exceed 80 degrees Celsius and to not exceed the melting temperature of the polymer. The selected temperature is dependent on the polymer. In some cases, 290-360 degrees Celsius may be suitable for the reaction. An exemplary reaction time is 3 hours. It is generally accepted that during crosslinking, reactive (Si—O) groups will react with other (Si—O) groups in adjacent molecules, resulting in crosslinking and densification; additionally, reactive silanes such as tetrakis(dimethylsiloxy)silane may react with more than one equivalent of PEEK, resulting in the structure shown.

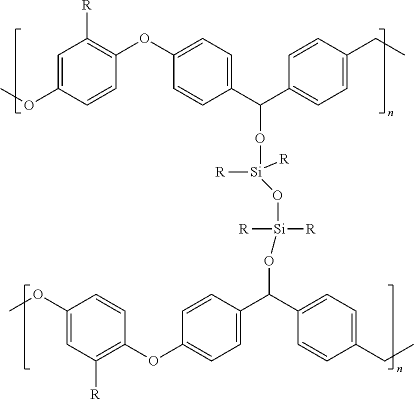

Crosslinking (i.e., “curing”) the silyl ether-containing polymer will produce a crosslinked polymer that has an increased molecular weight. The molecular weight of the crosslinked silyl ether-containing polymer will be greater than the molecular weight of the non-crosslinked silyl-ether containing polymer, e.g., the crosslinked silyl ether-containing polymer may have a molecular weight that is double or triple the molecular weight of the non-crosslinked silyl ether-containing polymer. As non-limiting examples, a molecular weight of a crosslinked silyl ether-containing polymer may be in a range from 12,000 to 102,000 Dalton, e.g., in a range from 22,000 to 84,000 Dalton for PEK, PEKK, and PEEK-based silyl ether-containing polymers.

A silyl ether-containing polymer as described may be useful in any application for which the silyl ether-containing polymer may be formed or incorporated into a useful article or device, such as a device or component of a fluid handling system. Exemplary devices include: tubing, piping, valves, fittings, connectors, pump housings, filter housings, gaskets, straight connectors, T-connectors, elbow connectors, multi-connector manifolds, heat exchangers, sensors, and other components of fluid handling systems that are useful to direct, control, or monitor a fluid flow (referred to herein as a flow control device). Exemplary sensors include flow controllers, regulators, flow meters, pressure meters, variable area meters, and the like.

Optionally, such components may be used in a fluid circuit of a fluid handling system that is additionally equipped with conductive components that perform an electrostatic discharge mitigation (EDS) function. These fluid circuits may include multiple conductive operative components and tubing segments. In certain examples, a fluid circuit for a predetermined fluid flow passageway (such as gases or liquids, or both) includes at least one inlet and at least one outlet. The fluid circuit includes multiple tubing segments and multiple of operative components, each operative component comprising a body portion with an internal fluid flow passageway and a plurality of tubing connector fittings, with the operative components connecting the tubing segments at selected tubing connector fittings. The tubing segments and operative components provide the fluid flow passageway through the fluid circuit. A tubing segment or an operative component may include: a non-conductive polymer portion that includes silyl ether containing-polymer to define the fluid passageway; and one or more interior conductive stripes that extend axially to ends of each of the respective tubing segments to allow assembly of a conductive path within the fluid circuit.

### EXAMPLES

The following describes a generic reaction scheme that is useful to prepare a silyl ether-containing polymer as described using a hydrosilylation reaction:
PEEK-OH Pellet Preparation:
   6 g of PEEK were added to a beaker. 15 mL of piranha solution (2:1 concentrated H₂SO₄: 30% H₂O₂) was prepared in a separate graduated cylinder, then added to the PEEK pellets. The pellets sat for 240 seconds, after which the piranha solution was neutralized with sodium bicarbonate followed by ascorbic acid. The pellets were washed with deionized water, then allowed to dry prior to subsequent reactions.
   Hydrosilylation General Procedure:
   6 g of PAEK (PEEK-OH, PEKK, or PEK) was added to a high-pressure reaction flask, possessing a PTFE threaded cap. 1.8 g of silane/siloxane is added, as well as 30 mg of Karstedt's catalyst (0.5 mass % w.r.t. PEEK) and 18 g PhSO₂. A PTFE-coated magnetic stir bar is then added, and the reaction flask is sealed. The reaction is heated to 160 C for 24 hours. Upon completion of the reaction, product is isolated via filtration using acetone as the eluent.
   Cure, Using a programmable furnace, the following heating profile was used:
   Ramp 30 C/min to 210 C, hold 210 C for 15 min
   Ramp 5 C/min to Max Temp, hold for 2 hours (Max Temp=290 C (PEKK), 330 C (PEEK), 360 C (PEK)
   Ramp 10 C/min to 210 C
   Furnace off @210 C, air cool to RT

### Example 1

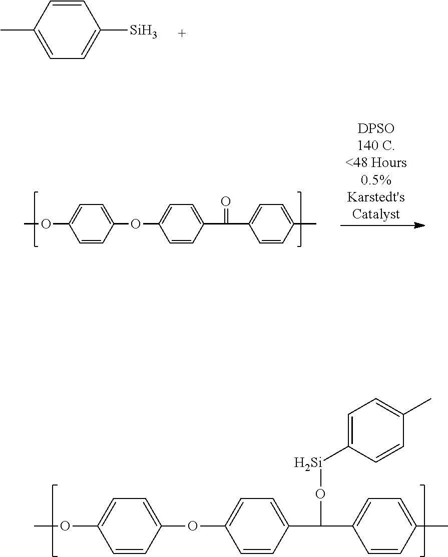

### Conditions:

Silane: Para (tolyl) silane
Solvent=diphenyl sulfone (DPSO)
Reaction time=48 hours
Reaction temperature=140 C
Catalyst=Karstedt's Catalyst

After reaction is complete, modified PEEK is cured at 330 C for 3 hours to cause cross-linking.

### Example 3

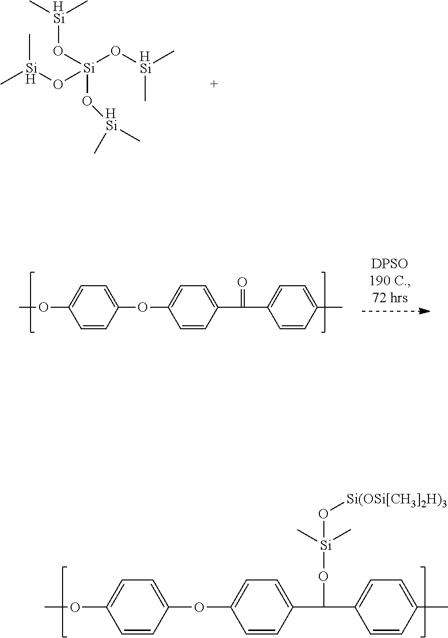

### Conditions:

Silane=Tetrakis(dimethylsiloxy)silane
Solvent=diphenyl sulfone (DPSO)
Reaction time=24-72 hours*
Reaction Temperature=140-190 C*
Catalyst=Karstedt's Catalyst *Reaction has been confirmed to run at lower temperatures if time is increased.

After reaction is complete, modified PEEK is cured at 330 C for 3 hours to cause crosslinking.

### Mechanical Property Testing

Unmodified PEEK and an example of modified PEEK as described herein were tested for mechanical properties, with the following results, showing improved Max Elongation and Toughness for the modified PEEK versus the unmodified PEEK:

Modified PEEK is a crosslinked version of the following silyl ether-containing polymer:

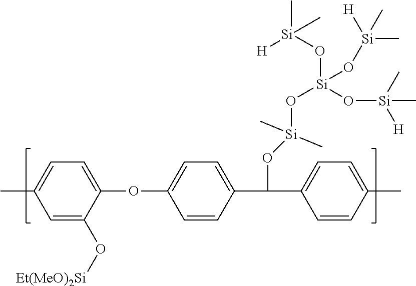

TABLE 1

| | Max | Max | Tensile | Elastic | |
|---|---|---|---|---|---|
| | Stress | Elongation | Modulus | Modulus | Toughness |
| Compound | (MPa) | (%) | (GPa) | (GPa) | (J) |
| Unmodified | 98 | 45 | 4.00 | / | / |
| PEEK | | | | | |
| Unmodified | 86.85 | 10 | 4.44 | 2.24 | 3.3 |
| PEEK | | | | | |
| Modified | 82.65 | 110 | 3.7 | 2.24 | 41 |
| PEEK | | | | | |

### Acid Resistance

Unmodified PEEK and examples of modified PEEK as described herein were tested for acid resistance, with the following results, showing improved Max Elongation and Toughness for the modified PEEK versus the unmodified PEEK:

The examples of modified PEEK are as follows, with A, B, and D being crosslinked versions of the following silyl ether-containing polymers:

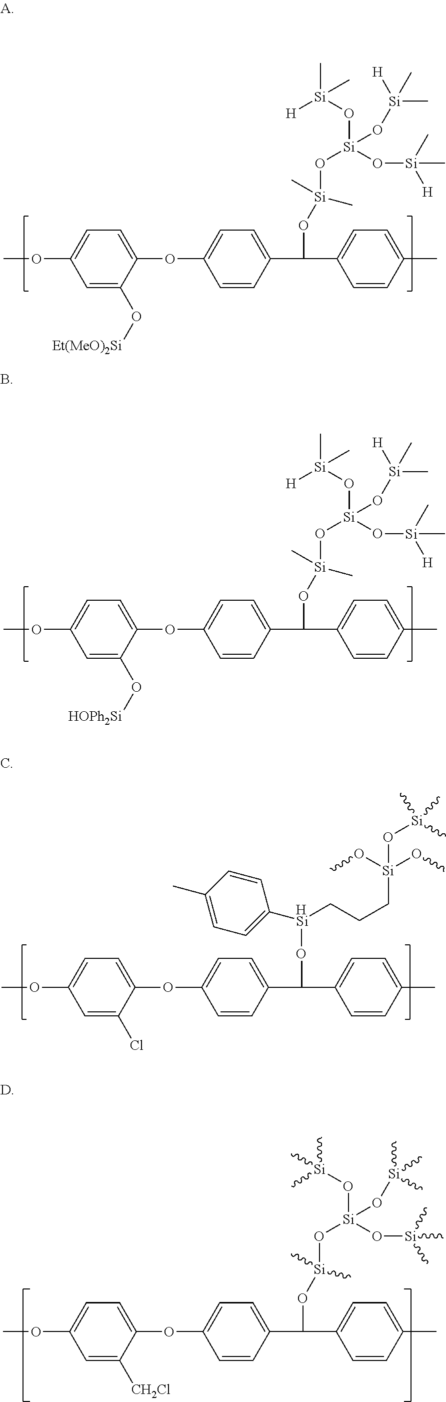

TABLE 2

| Exposure Time (hours): | <2 | 6 | 10 | 24 | 48 | 72 | 96 | 120 |
|---|---|---|---|---|---|---|---|---|
| Victrex 450PF | 3 | 3 | 3 | 3 | 3 | 3 | 3 | 3 |
| PEEK Pellet | 3 | 3 | 3 | 3 | 3 | 3 | 3 | 3 |
| PEEK-pTolSiH₃-Cured | 1 | 2 | 3 | 3 | 3 | 3 | 3 | 3 |
| PEEK-OH-TDSS-EtMOS | 1 | 1 | 1 | 1 | 2 | 3 | 3 | 3 |
| (A) Cured | | | | | | | | |
| PEEK-OH-TDSS-Ph₂Si(OH)₂ | 1 | 1 | 1 | 2 | 3 | 3 | 3 | 3 |
| (B) Cured | | | | | | | | |
| PEEK-Cl—Si—Si (C) Cured | 1 | 1 | 1 | 2 | 3 | 3 | 3 | 3 |
| PEEK-CH₂Cl—Si-Cured (D) | 1 | 1 | 1 | 1 | 1 | 2 | 2 | 3 |

A value of 1 indicates a 0-0.02% change in mass or volume of sample that is between 0 and 0.02 percent. A change in mass or volume shows material deformation. A value of 2 shows a change in mass or volume that is between 0.02 and 0.5 percent. A value of 3 shows a change in mass or volume that is greater than 0.5 percent, indicating a material deformation.

### Embodiments

Aspects, including embodiments, of the disclosure described herein may be beneficial alone or in combination, with one or more other aspects or embodiments. Without limiting the foregoing description, certain non-limiting embodiments of the disclosure numbered 1-20 are provided below. As will be apparent to those of skill in the art upon reading this disclosure, each of the individually numbered embodiments may be used or combined with any of the preceding or following individually numbered embodiments. This is intended to provide support for all such combinations of embodiments and is not limited to combinations of embodiments explicitly provided below:

Embodiment (1) presents a silyl ether-containing polymer comprising: an organic polymer, and a silyl group connected to the organic polymer through an oxygen atom.

Embodiment (2) presents the silyl ether-containing polymer of embodiment (1) comprising silyl ether groups having the formula

—O—SiR1R2R3

wherein each R1 and R2 is independently hydrogen or an organic group, and R3 is hydrogen, an organic group, a divalent group that connects to another silicon atom, or an oxygen atom that connects to another silicon atom or an organic group.

Embodiment (3) presents the silyl ether-containing polymer of any one of embodiments (1)-(2), wherein each of R1 and R2 is independently hydrogen or an organic group (e.g., an alkyl, an alkoxy, an aromatic group, or hydroxy group), and R3 is a hydrogen, an organic group (e.g., an alkyl, an alkoxy, an aromatic group, or a hydroxy (—OH) group), or a divalent oxygen or organic group that connects to another silicon atom.

Embodiment (4) presents the silyl ether-containing polymer of any one of embodiments (1)-(3), comprising silyl ether groups having the formula

—O—SiR1R2R3

wherein each R1 and R2 is independently hydrogen or an organic group; and R3 is X—Si(R4)(R5), wherein X is a divalent oxygen or a divalent alkylene, and each R4 and R5 is an oxygen connected to a silicon atom.

Embodiment (5) presents the silyl ether-containing polymer of embodiment (1), comprising a silyl ether group selected from the structures shown in claim 5.

Embodiment (6) presents the silyl ether-containing polymer of embodiment (1), comprising silyl ether groups having a formula selected from the formulas shown in claim 6.

Embodiment (7) presents the silyl ether-containing polymer of any one of embodiments (1)-(6), wherein the organic polymer comprises poly(aryl ether ketone).

Embodiment (8) presents the silyl ether-containing polymer of embodiment (7), wherein the poly(aryl ether ketone) comprises polyether ether ketone (PEEK), polyether ketone ketone (PEKK), or polyether ketone (PEK).

Embodiment (9) presents the silyl ether-containing polymer of any one of embodiments (1)-(8), wherein the organic polymer comprises polyvinyl phenol, polyvinyl alcohol, or polyketone.

Embodiment (10) presents the silyl ether-containing polymer of any one of embodiments (1)-(9) wherein the silyl ether-containing polymer is a temperature-stable thermoplastic.

Embodiment (11) presents the silyl ether-containing polymer of any one of embodiments (1)-(10) wherein the silyl ether-containing polymer has a molecular weight in a range from 15,000 Dalton to 105,000 Dalton.

Embodiment (12) presents the silyl ether-containing polymer of any one of embodiments (1)-(11) wherein the silyl group is connected at one end to a polymer backbone through an oxygen atom and is connected at a second end to a second polymer backbone through an oxygen atom.

Embodiment (13) presents a flow control device comprising a silyl ether-containing polymer of any one of embodiments (1)-(12), the flow control device comprising: tubing, piping, a valve, a fitting, a connector, a pump housing, a gasket, a connector, a manifold, a heat exchanger, or a sensor.

Embodiment (14) presents a method of preparing a silyl ether-containing polymer, the method comprising reacting organic polymer comprising an organic backbone and a reactive oxygen group, with reactive silicon compound, to attach a silicon atom of the reactive silicon compound to the organic polymer through an oxygen atom of the reactive oxygen groups.

Embodiment (15) presents the method of embodiment (14) comprising reactive oxygen groups selected from a carbonyl and a hydroxy group.

Embodiment (16) presents the method of any one of embodiments (14)-(15), wherein the reactive oxygen group comprises a carbonyl group and the reactive silicon compound comprises a reactive silicon-hydrogen bond.

Embodiment (17) presents the method of any one of embodiments (16) wherein the reactive silicon compound has the formula: H—SiR1R2R3 wherein each R1 and R2 is independently hydrogen or an organic group, and R3 is hydrogen, an organic group, a divalent group that connects to another silicon atom, or an oxygen atom that connects to another silicon atom or an organic group.

Embodiment (18) presents the method of embodiment (16) wherein the reactive silicon compound is selected from tetrakis(dimethylsiloxy)silane, para(tolyl)silane, diphenylsilane, phenylsilane, triphenylsilane, and poly(methyl-hydrosilsesquioxane).

Embodiment (19) presents the method of any one of embodiments (14)-(18), wherein the reactive oxygen group comprises a hydroxy group and the reactive silicon compound comprises a reactive silicon-oxygen-R group, wherein R is hydrogen or an alkyl.

Embodiment (20) presents the method of any one of embodiments (14)-(19), wherein the reactive oxygen group comprises a hydroxy group and the reactive silicon compound comprises a reactive silicon-oxygen-R group, wherein R is hydrogen or methyl.

Embodiment (21) presents the method of embodiment (19) or (20) wherein the reactive silicon compound has the formula: R—O—SiR1R2R3 wherein R is hydrogen or an alkyl, each R1 and R2 is independently hydrogen or an organic group, and R3 is hydrogen, an organic group, a divalent group that connects to another silicon atom, or an oxygen atom that connects to another silicon atom or an organic group.

Embodiment (22) presents the method of embodiment (21), wherein the reactive silicon compound is: [Structure of silicon compound with R═H, CH3].

Embodiment (23) presents the method of embodiment (20), wherein the reactive silicon compound is: a silanol selected from: silanediol, diphenylsilanediol, diisobutylsilanediol, tris(tertbutoxy)silanol, tertbutylsilanetriol, and poly(methylsilsesquioxane), or a silyl ether selected from tetraethoxysilane, ethyl(trimethoxy)silane, tetramethoxysilane, tetramethoxysilane oligomeric hydrolysate, methoxy terminated poly(methylsilsesquioxane), and a silsesquioxane.

Embodiment (24) presents the method of embodiments (14)-(23), wherein the organic polymer comprises poly(aryl ether ketone).

Embodiment (25) presents the method of embodiment (24), wherein the poly(aryl ether ketone) comprises polyether ether ketone (PEEK), polyether ketone ketone (PEKK), or polyether ketone (PEK).

Embodiment (26) presents the method of any one of embodiments (14)-(25), wherein the organic polymer comprises polyvinyl phenol, polyvinyl alcohol, or polyketone.

Embodiment (27) presents the method of any one of embodiments (14)-(26) wherein the organic polymer is a temperature-stable thermoplastic.

Embodiment (28) presents the method of any one of embodiments (14)-(27) wherein the organic polymer has a molecular weight in a range from 10,000 to 100,000 Dalton.

Embodiment (29) presents the method of any one of embodiments (14)-(28) comprising curing the silyl ether-containing polymer to produce a crosslinked silyl ether-containing polymer wherein the silyl group is connected at one end to a polymer backbone through an oxygen atom and is connected at a second end to a second polymer backbone through an oxygen atom.

Embodiment (30) presents the method of any one of embodiments (14)-(29) wherein: the silyl ether-containing polymer has increased maximum elongation compared to the organic polymer, or the silyl ether-containing polymer has increased toughness compared to the organic polymer, or the silyl ether-containing polymer has increased resistance to concentrated sulfuric acid compared to the organic polymer, or two or more of these.

Embodiment (31) presents a flow control device comprising silyl ether-containing polymer comprising: organic polymer, and a silyl group connected to the organic polymer through an oxygen atom.

Embodiment (32) presents the flow control device of embodiment 31 comprising silyl ether groups having the formula: —O—SiR1R2R3 wherein each R1 and R2 is independently hydrogen or an organic group, and R3 is hydrogen, an organic group, a divalent group that connects to another silicon atom, or an oxygen atom that connects to another silicon atom or an organic group.

Embodiment (33) presents the flow control device of any one of embodiment (31)-(32), wherein: each of R1 and R2 is independently hydrogen or an organic group (e.g., an alkyl, an alkoxy, an aromatic group, or hydroxy group), and R3 is a hydrogen, an organic group (e.g., an alkyl, an alkoxy, an aromatic group, or a hydroxy (—OH) group), or a divalent oxygen or organic group that connects to another silicon atom.

Embodiment (34) presents the flow control device of any of embodiments (31)-(33), the flow control device comprising: tubing, piping, a valve, a fitting, a connector, a pump housing, a gasket, a connector, a manifold, a heat exchanger, or a sensor.

The use of the terms “a” and “an” and “the” and “at least one” and similar referents in the context of describing the disclosure (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A silyl ether-containing polymer comprising:
organic polymer, and
a silyl group connected to the organic polymer through an oxygen atom.

2. The silyl ether-containing polymer of claim 1 comprising silyl ether groups having the formula: 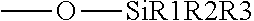
wherein
each R1 and R2 is independently hydrogen or an organic group, and
R3 is hydrogen, an organic group, a divalent group that connects to another silicon atom, or an oxygen atom that connects to another silicon atom or an organic group.

3. The silyl ether-containing polymer of claim 2, wherein:
each of R1 and R2 is independently hydrogen or an organic group (e.g., an alkyl, an alkoxy, an aromatic group, or hydroxy group), and R3 is a hydrogen, an organic group (e.g., an alkyl, an alkoxy, an aromatic group, or a hydroxy (—OH) group), or a divalent oxygen or organic group that connects to another silicon atom.

4. The silyl ether-containing polymer of claim 2, comprising silyl ether groups having the formula: 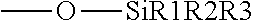
wherein
each R1 and R2 is independently hydrogen or an organic group; and
R3 is X—Si(R4)(R5), wherein X is a divalent oxygen or a divalent alkylene, and each R4 and R5 is an oxygen connected to a silicon atom.

5. The silyl ether-containing polymer of claim 1, comprising a silyl ether group selected from:

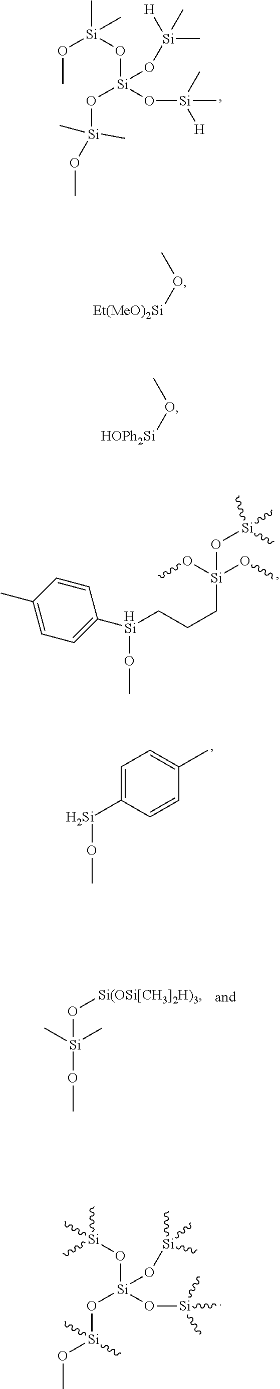

6. The silyl ether-containing polymer of claim 1 comprising silyl ether groups having a formula selected from: 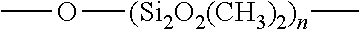
wherein n is in a range from 1 to 10, 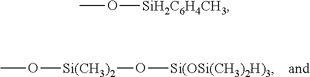
oligomeric silicates and oligomeric siloxanes such as poly(dimethylsiloxane)

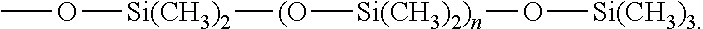

7. The silyl ether-containing polymer of claim 1, wherein the organic polymer comprises poly(aryl ether ketone).

8. The silyl ether-containing polymer of claim 7, wherein the poly(aryl ether ketone) comprises polyether ether ketone (PEEK), polyether ketone ketone (PEKK), or polyether ketone (PEK).

9. The silyl ether-containing polymer of claim 1, wherein the organic polymer comprises polyvinyl phenol, polyvinyl alcohol, or polyketone.

10. The silyl ether-containing polymer of claim 1, wherein the silyl ether-containing polymer is a temperature-stable thermoplastic.

11. The silyl ether-containing polymer of claim 1, wherein the silyl ether-containing polymer has a molecular weight in a range from 15,000 Dalton to 105,000 Dalton.

12. The silyl ether-containing polymer of claim 1, wherein the silyl group is connected at one end to a polymer backbone through an oxygen atom and is connected at a second end to a second polymer backbone through an oxygen atom.

13. A flow control device comprising a silyl ether-containing polymer of claim 1, the flow control device comprising: tubing, piping, a valve, a fitting, a connector, a pump housing, a gasket, a connector, a manifold, a heat exchanger, or a sensor.

14. A method of preparing a silyl ether-containing polymer, the method comprising reacting
organic polymer comprising an organic backbone and a reactive oxygen group, with
reactive silicon compound,
to attach a silicon atom of the reactive silicon compound to the organic polymer through an oxygen atom of the reactive oxygen groups.

15. The method of claim 14 comprising reactive oxygen groups selected from a carbonyl and a hydroxy group.

16. The method of claim 14, wherein the reactive oxygen group comprises a carbonyl group and the reactive silicon compound comprises a reactive silicon-hydrogen bond.

17. The method of claim 16, wherein the reactive silicon compound has the formula: 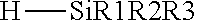
wherein
each R1 and R2 is independently hydrogen or an organic group, and
R3 is hydrogen, an organic group, a divalent group that connects to another silicon atom, or an oxygen atom that connects to another silicon atom or an organic group.

18. The method of claim 16, wherein the reactive silicon compound is selected from tetrakis(dimethylsiloxy)silane, para(tolyl)silane, diphenylsilane, phenylsilane, triphenylsilane, and poly(methyl-hydrosilsesquioxane).

19. The method of claim 14, wherein the reactive oxygen group comprises a hydroxy group and the reactive silicon compound comprises a reactive silicon-oxygen-R group, wherein R is hydrogen or an alkyl.

20. The method of claim 14, wherein the reactive oxygen group comprises a hydroxy group and the reactive silicon compound comprises a reactive silicon-oxygen-R group, wherein R is hydrogen or methyl.

21. The method of claim 19, wherein the reactive silicon compound has the formula: 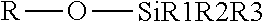
wherein
R is hydrogen or an alkyl,
each R1 and R2 is independently hydrogen or an organic group, and
R3 is hydrogen, an organic group, a divalent group that connects to another silicon atom, or an oxygen atom that connects to another silicon atom or an organic group.

22. The method of claim 21, wherein the reactive silicon compound is:

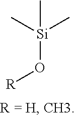

23. The method of claim 20, wherein the reactive silicon compound is:
a silanol selected from: silanediol, diphenylsilanediol, diisobutylsilanediol, tris(tertbutoxy)silanol, tertbutylsilanetriol, and poly(methylsilsesquioxane), or
a silyl ether selected from tetraethoxysilane, ethyl(trimethoxy)silane, tetramethoxysilane, tetramethoxysilane oligomeric hydrolysate, methoxy terminated poly(methylsilsesquioxane), and a silsesquioxane.

24. The method of claim 14, wherein the organic polymer comprises poly(aryl ether ketone).

25. The method of claim 24, wherein the poly(aryl ether ketone) comprises polyether ether ketone (PEEK), polyether ketone ketone (PEKK), or polyether ketone (PEK).

26. The method of claim 14, wherein the organic polymer comprises polyvinyl phenol, polyvinyl alcohol, or polyketone.

27. The method of claim 14 wherein the organic polymer is a temperature-stable thermoplastic.

28. The method of claim 15, wherein the organic polymer has a molecular weight in a range from 10,000 to 100,000 Dalton.

29. The method of claim 14, comprising curing the silyl ether-containing polymer to produce a crosslinked silyl ether-containing polymer wherein the silyl group is connected at one end to a polymer backbone through an oxygen atom and is connected at a second end to a second polymer backbone through an oxygen atom.

30. The method of claim 14, wherein:
the silyl ether-containing polymer has increased maximum elongation compared to the organic polymer, or
the silyl ether-containing polymer has increased toughness compared to the organic polymer, or
the silyl ether-containing polymer has increased resistance to concentrated sulfuric acid compared to the organic polymer, or
two or more of these.
